(19) United States
(12) Patent Application Publication
(10) Pub. No.: US 2026/0105037 A1
(43) Pub. Date: Apr. 16, 2026

(54) PARTITIONING OF INVERTED FILE (IVF) VECTOR INDEXES IN A DATABASE SYSTEM

(71) Applicant: Oracle International Corporation, Redwood Shores, CA (US)

(72) Inventors: Qingchun Jiang, Foster City, CA (US); Aurosish Mishra, Foster City, CA (US); Agnivo Saha, Belmont, CA (US); Boriana Milenova, Reading, MA (US); Rafi Ahmed, Fremont, CA (US); Congnan Luo, San Diego, CA (US); Ananth Raghavan, San Francisco, CA (US); Shasank Kisan Chavan, Menlo Park, CA (US)

(21) Appl. No.: 19/064,677

(22) Filed: Feb. 26, 2025

Related U.S. Application Data
(60) Provisional application No. 63/706,724, filed on Oct. 13, 2024.

(51) Int. Cl. G06F 16/22; G06F 16/28

(52) U.S. Cl. CPC G06F 16/2237; G06F 16/285

(57) ABSTRACT

Techniques for partitioning an inverted file (IVF) vector index in a database system are provided. In one technique, a partitioned IVF index is generated based on vectors in a base table using the following process. First, a first clustering technique is performed on vectors in a first subset of the base table. Such clustering results in a first plurality of clusters of vectors. For each cluster, a centroid of that cluster is identified, the centroid is stored in a first partition of a centroids table of the partitioned IVF index, the vectors in that cluster are stored in a first subpartition of a clusters table of the partitioned IVF index (where the first subpartition corresponds to the first partition of the centroids table), and a first association is stored between the centroid and the first subpartition. This clustering repeats for each subset of the base table.

### TECHNICAL FIELD

The present disclosure relates to IVF vector indexes and, more particularly, to partitioning IVF vector indexes in a database system.

### BACKGROUND

Vectors (also known as “vector embeddings”) are mathematical representations that capture the semantic content of data in a high-dimensional vector space. Such data may be structured or unstructured, such as images, text, audio, or video. Vectors encode key features or attributes of data, and are commonly generated by machine-learned (ML) embedding models, such as Transformers, Convolutional Neural Networks (CNNs), etc. Vectors allow for similarity search by leveraging the property that an embedding generator, given similar data items, produce vectors that are closer to each other in the high-dimensional vector space. Vector search has become ubiquitous in modern enterprise artificial intelligence (AI) applications, such as search engines and intelligent chat assistants.

Embedding unstructured data, such as documents in a database, often generates significantly more vectors than the number of documents themselves. This occurs because documents are typically split into smaller chunks, and a vector embedding is created for each chunk to accurately capture the document's full semantic content. For example, a single PDF document may produce tens of thousands of vector embeddings, with each embedding representing a different chunk (e.g., corresponding to a section, page, or paragraph) and potentially having thousands of dimensions. Performing vector search by exhaustively comparing the vector representation of a user query (e.g., a natural language question) with each vector in the database is computationally expensive and extremely time-consuming. Hence, database systems may create vector indexes that organize vectors by similarity and enable ultra-fast approximate vector searches.

A widely used vector index is the Inverted File Index (IVF), which clusters vectors based on similarity using algorithms such as K-Means Clustering. In an IVF index, each cluster is represented by a centroid vector, and vectors from the base table are assigned to their closest centroid. During a search, the centroid clusters are ranked based on the similarity of their centroid vectors to the query vector. Only a subset of the closest clusters is selected for further comparison. By limiting the search to the vectors in these closest clusters, IVF significantly reduces search latency while maintaining a high likelihood of returning the Top K closest matches.

While similarity search has become a fundamental task in many AI applications where low latency is critical for performance, challenges still exist. For example, as the number of vectors in a database grows, managing tables with billions or even trillions of high-dimensional vectors becomes increasingly challenging. Scaling the performance of an IVF index in such scenarios is incredibly difficult. As a specific example, maintaining a single monolithic IVF index can cause imbalanced cluster sizes, strain system memory and computational resources, and lead to unpredictable latency during searches. Thus, there is a pressing requirement in database systems to further accelerate similarity search on these massive vector datasets.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example database system for managing a partitioned IVF index, in an embodiment;

FIG. 2 is a diagram that depicts an example set of five clusters that is generated based on a clustering algorithm, in an embodiment;

FIG. 3 is a diagram that depicts a subset of clusters that are selected based on distance calculations between query vector and centroids in one or more clusters;

FIG. 4 is a block diagram that depicts an example partitioned IVF index, in an embodiment;

FIG. 5 is a block diagram that depicts an example partitioned local IVF index that is generated based on a composite partitioned base table, in an embodiment;

FIG. 6 is a block diagram that depicts an example in-memory centroids cache for a partitioned IVF index, in an embodiment;

FIG. 7 is a flow diagram that depicts an example process for generating a partitioned IVF index based on vectors in a base table, in an embodiment;

FIG. 8 is a block diagram that illustrates a computer system upon which an embodiment of the invention may be implemented;

FIG. 9 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

A system and method for implementing IVF indexes in a database system are provided. In one technique, vectors in a base table are partitioned and an IVF index on each partition is constructed. Each table partition and IVF index partition may have its own dedicated tablespace which enables efficient management of the IVF index at the scale of trillions of vectors.

In a related technique, the partitioning mechanism of the base table is decoupled from that of the partitioned IVF index, allowing for independent index creation. This enables a database system to manage various partitioning schemes, including composite partitioning schemes, without being tied to how the base table itself is partitioned.

In a related technique, flexible clustering models are applied to the table partitions, building independent cluster models based on the unique characteristics of the vectors within that partition. This includes the ability to provide users with the flexibility to use different distance metrics to cluster data in each partition. To further optimize performance, sampling techniques, SIMD-optimized memory caching, and parallel execution are implemented to accelerate creation of partitioned IVF indexes.

In a related technique, to enhance search efficiency, partition pruning techniques are introduced to limit searches to only relevant index partitions. Within these relevant index partitions, only a subset of centroid clusters are scanned, ranked by their centroid's proximity to the query vector, improving both speed and accuracy.

Embodiments improve computer-related technology related to vector database systems. Embodiments enable efficient IVF index creation and powers scalable similarity searches on cloud-scale vector datasets for both large and small enterprise use cases.

### SYSTEM OVERVIEW

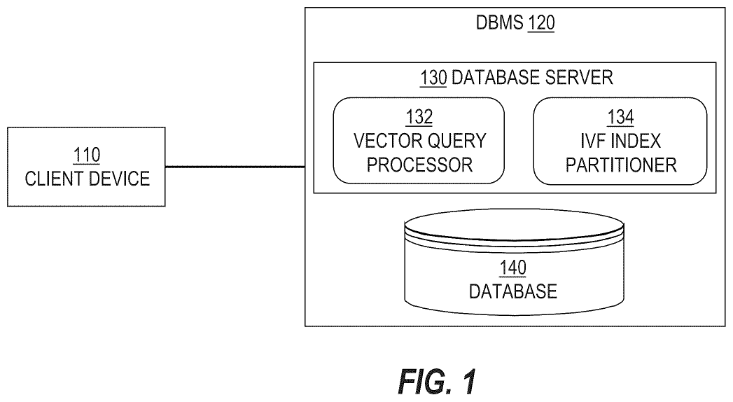

FIG. 1 is a block diagram that depicts an example database system 120 for managing a partitioned IVF index, in an embodiment. Database system 120 is communicatively coupled to a client device 110 either directly or over one or more computer networks, such as a LAN, WAN, or the Internet. Although only one client device is depicted, database system 120 may be communicatively coupled with multiple client devices and, therefore, support multiple concurrent client requests.

Database system 120 comprises a database server 130 and a database 140. Database server 140 may execute on a single computing node or on multiple computing nodes that are connected to database 140. Thus, multiple instances of database server 130 may be distributed across multiple computing nodes.

Database server 130 comprises a vector query processor 132 and an IVF index partitioner 134. Vector query processor 132 accepts vector queries that are submitted by client device 110 and/or retrieved from storage and run regularly. Vector query processor 132 generates results from executing a vector query and transmits the results to the submitter thereof (e.g., client device 110), to another entity, and/or to persistent storage (e.g., database 140) for later access by a requesting entity.

Database server 130 may generate an IVF index (or receive the IVF index from another entity, such as another database server, not depicted) and optionally stores the centroids of the IVF index in volatile memory to speed up index creation, DML statements, and query processing. (IVF indexes are described in more detail herein.) Depending on the size of available memory of database server 130, a centroids table is cached in memory for non-partitioned IVF indexes when possible. For partitioned IVF indexes, some or all partitions of the centroids table is cached in memory when possible.

IVF index partitioner 134 partitions the IVF index based on one or more criteria, as described in more detail herein.

Database 140 persistently stores data, including one or more base tables (e.g., base table 142), each containing vector data. For example, base table 142 comprises multiple columns, one of which stores vector data. Other columns store other data about data items represented in base table 142, such as a row identifier, a data item identifier, and one or more other attributes of the data items. Each row in base table 142 corresponds to a data item, such as text data, audio data, video data, or image data. For example, a data item may be a portion of a document and the vector data for the data item may be a vector embedding that was generated by an embedding generator based on portion of the document as input thereto. Database 140 may also store all or a portion of the IVF index that IVF index partitioner 134 partitions.

### IVF Index

An IVF index is a vector index (of vectors that are stored in a base table, such as base table 142) that is organized based on clustering. Example clustering techniques include K-means clustering, Hierarchical clustering, DBSCAN, Fuzzy clustering, Gaussian mixture models (GMMs), Spectral clustering, and Affinity propagation. Although multiple clustering techniques may be selected to perform clustering on vectors in a base table, the following description is in the context of K-means clustering, which identifies multiple centroids within a vector space and assigns each vector (in a set of vectors) to the nearest centroid. The resulting assignment comprises a set of clusters, each cluster comprising a single centroid and multiple vectors that are assigned to that centroid. Each vector is assigned to a single centroid. A centroid may be the center-most vector in a cluster or may be a derived vector that is an aggregate (e.g., average) of the vectors assigned to a cluster. Each centroid may be updated based on the mean of the vectors in the corresponding cluster when needed.

K-means clustering algorithm is applied to a set of vectors to generate K clusters. The value of K (or the number of clusters) may be based on the number of vectors. For example, K=sqrt(N), where N is the number of vectors. Each cluster is identified by a centroid, which is a value that is conceptually the average of the vectors that are assigned to that cluster. The centroid of a cluster may be considered the “center of gravity” of the cluster. A goal in determining a centroid is to minimize a total distance between vectors within a cluster and the centroid, so that each centroid is a good representative value for its cluster.

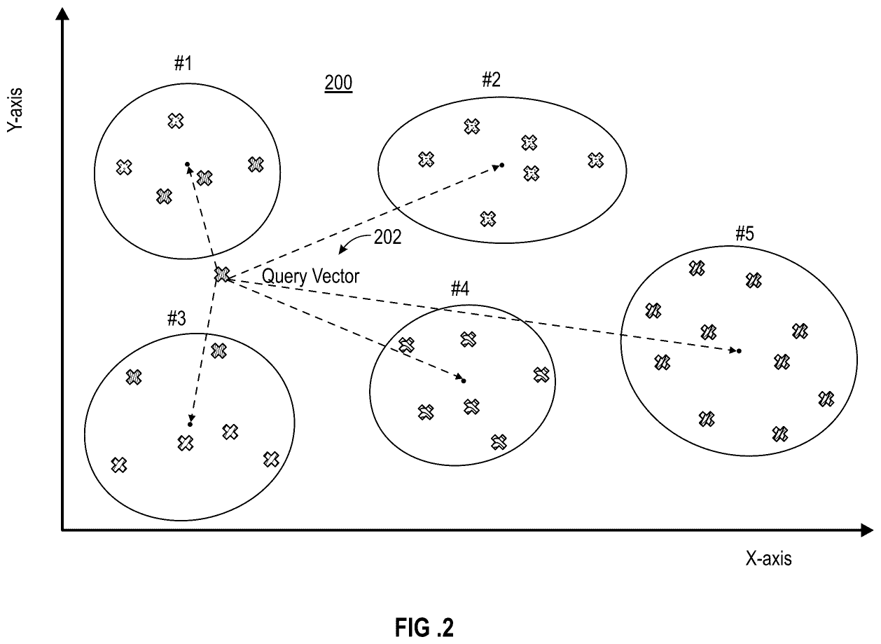

FIG. 2 is a diagram that depicts an example set of five clusters 200 that is generated based on a clustering algorithm, in an embodiment. In this example, vectors are two-dimensional and, therefore, may be mapped onto a two-dimensional plane with an X-axis and a Y-axis. However, some vectors may have hundreds of dimensions. FIG. 2 also depicts a query vector 202 that is not in any of the five clusters 200.

An IVF index comprises two types of tables: (1) a centroid table that stores all the centroids of all the clusters; and (2) a cluster table with K partitions, each of which corresponds to a single cluster and a single centroid and stores the vectors that are assigned to that cluster based on closeness to the centroid represented by the cluster. In a similarity search, given query vector 202, the centroid table is searched first (referred to as the “first-level search”) to identify one or more centroids that are the most similar to (or has the lowest distance to) query vector 202. Thus, either only a single centroid is selected from the centroid table or multiple centroids are selected from the centroid table. The number of centroids to select may be a default value (e.g., two), may be based on vector distance from the query vector, and/or may be a value specified in the corresponding vector query that includes the query vector. (For example, select the closest three centroids that are within D vector distance from the query vector.) In the example of FIG. 2, a vector distance calculation is performed for each pair of vectors, each pair comprising query vector 202 and a different centroid of clusters 200. Because there are five clusters 200, five pairs are considered and five distance calculations are performed.

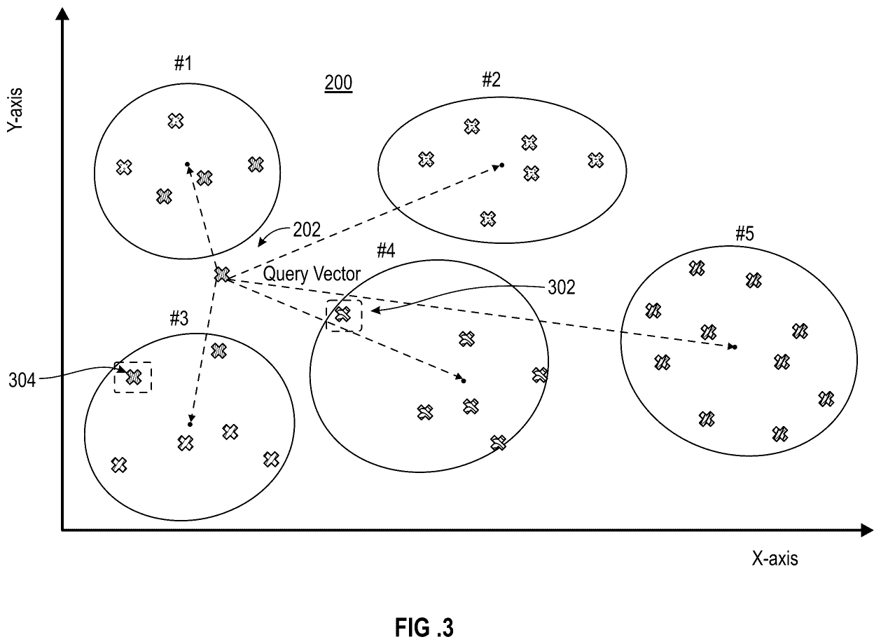

FIG. 3 is a diagram that depicts a subset of clusters that are selected based on distance calculations between query vector 202 and centroids in clusters 200. In this example, two clusters are selected, which may be due to a threshold distance that each distance between a query vector and a corresponding centroid must be under in order to be considered a candidate cluster to search. Additionally or alternatively, two clusters are selected due to a pre-defined number of centroids to select (“n-probe”). In this example, the centroids in clusters #1 and #3 are selected from among the five centroids in clusters 200. However, because cluster #4 is not part of the second-level search, vector 302 cannot be considered a candidate vector. Also, vector 304 can be selected as a candidate vector, even though vector 302 is closer to query vector 202 than vector 304.

Then, for each selected centroid, the cluster table to which that identified centroid belongs is searched to identify one or more vectors. This search is referred to as a “second-level search.” If the query vector is for the Top K, then the Top K vectors in each identified cluster table are identified and then the Top K from the Top K of each identified cluster table are selected. Even if the query vector is closer to a centroid associated with one cluster table, the closest vector to the query vector may be in another cluster table. Thus, searching one cluster table might not be sufficient for an accurate search; searching multiple cluster tables is generally prudent.

### Partitioned IVF Index

In an embodiment, an IVF index is partitioned, meaning that the centroids table is partitioned and the vectors in the cluster tables are partitioned beyond the “partitioning” or clustering that occurs based on vector-cluster assignment. IVF index partitioner 134 may generate the partitioned IVF index from a partitioned base table or from a non-partitioned base table The partitioning is based on one or more partitioning keys. A partitioning key may be any value associated with a base table of vectors, such as one of the columns of the base table. An example of a partitioning key may be any combination of last name, start date, salary range, employer identifier, delivery date.

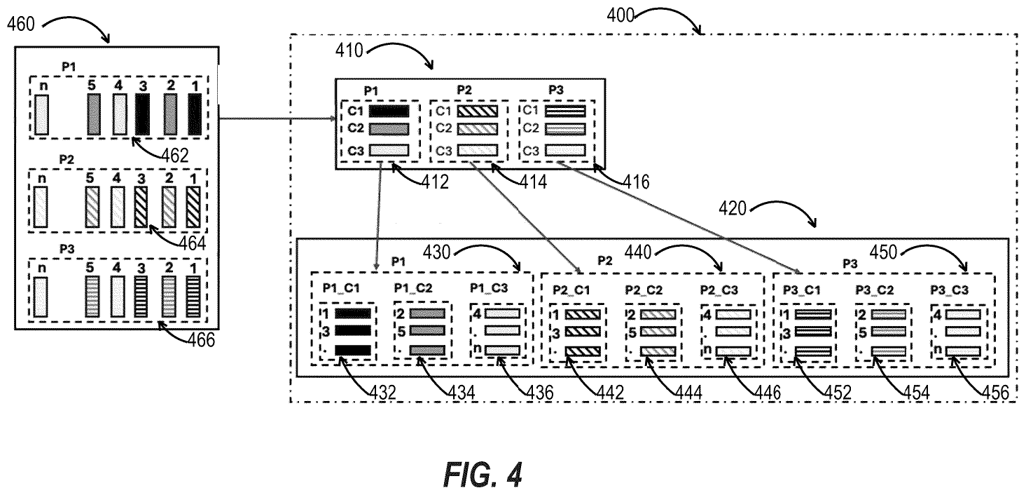

FIG. 4 is a block diagram that depicts an example partitioned IVF index 400, in an embodiment. Partitioned IVF index 400 comprises a centroids table 410 that is partitioned (by partition ID) into partitions 412-416, each of which comprises a different set of centroids. Each partition of centroids table 410 is associated with a different partition of clusters table 420 (and all the subpartitions of that partition). Clusters table 420 is composite partitioned (first by partition ID and then by centroid ID) to create cluster table partitions 430-450. Cluster table partition 430 comprises cluster subpartitions 432-436 for centroids table partition 412, cluster table partition 440 comprises cluster subpartitions 442-446 for centroids table partition 414, and cluster table partition 450 comprises cluster subpartitions 452-456 for centroids table partition 416. Each subpartition 432-456 corresponds to a different centroid in centroids table 410 and, thus, stores vectors that have been deemed closer (in terms of vector similarity) to that corresponding centroid than to any other centroid in centroids table 410.

In FIG. 4, base table 460 (upon which partitioned IVF index 400 is built) is partitioned by the same partitioning key as partitioned IVF index 400. Thus, partition 462 may correspond to centroids table partition 412, partition 464 may correspond to centroids table partition 414, and partition 466 may correspond to centroids table partition 416. However, the logical or physical ordering of partitions in base table 460 may be different than the logical or physical ordering of partitions in centroids table 410. Thus, partition 462 may correspond to centroids table partition 414, partition 464 may correspond to centroids table partition 416, and partition 466 may correspond to centroids table partition 412.

In an alternative embodiment, a base table (e.g., base table 460) is not partitioned by the same partitioning key as the centroids table (e.g., centroids table 410). Thus, the base table may be partitioned by a different partitioning key or might not be partitioned at all.

Partitioned IVF index 400 may be partitioned using one of multiple partitioning methods. Examples of partitioning methods include list partitioning, hash partitioning, range partitioning, interval partitioning, reference partitioning, and system partitioning. In a scenario where base table 460 is partitioned, partitioned IVF index 400 may be partitioned using the same partitioning method as (or using a different partitioning method from) the partitioning method that was used to partition base table 460. For example, base table partitions 462-466 may be range partitioned by the partition key, whereas the corresponding partitions in centroids table 410 and clusters table 420 of partitioned IVF index 400 may be list partitioned by partition ID (e.g., a data object ID).

In an embodiment, a local partitioned IVF index supports base tables that are partitioned by either a single-column or a set of columns. A column may be a simple user-defined column or a derived virtual column from an expression.

If base table 460 is partitioned, then the partition ID upon which centroids table 410 is partitioned may be an object ID of the corresponding partition in base table 460. This would mean that partitioned IVF index 400 is a “local” index. If base table 460 is not partitioned, then the partition ID upon which centroids table 410 is partitioned may be a unique ID computed from the partition key values. As indicated herein, a partitioned IVF index may be (a) local partitioned (which means there is a 1:1 relationship between the base table partitions and the IVF index partitions or (b) globally partitioned (which means there is m:n relationship between the base table partitions and the IVF index partitions). In this case where the base table is not partitioned, a virtual unique ID that is computed from partition key values may be used as the partition ID. If the base table is not partitioned, then the base table may be considered a single partition and the cluster table in the IVF index will not have a partition ID column. The virtual unique ID computed from column values of partition key columns would still be used.

In an embodiment where partitioned IVF index 400 is a local index, each partition and subpartition in IVF index 400 is associated with a unique data object number, which is used to uniquely identify a data partition or subpartition. By using a unique identifier, a partition local IVF index effectively decouples index partition methods from the base table partition methods. This allows a local partitioned IVF index to be created on any partitioned base tables regardless of its partitioning methods and its partitioning levels.

In an embodiment, there are four ways to refer to an IVF index: (1) reference to “IVF index” indicates that the IVF index is either partitioned or non-partitioned and the IVF index is based on a base table that is either partitioned or non-partitioned; (2) reference to a “global IVF index” indicates that the IVF index is not partitioned, but the base table may be partitioned or non-partitioned; (3) reference to a “partitioned IVF index” indicates that the IVF index is partitioned and the base table may be partitioned or non-partitioned; and (4) reference to a “local partitioned IVF index” indicates that the IVF index is partitioned and is based on a partitioned base table where the [sub]partitions of the partitioned IVF index and the [sub]partitions in the base table have a 1 to 1 mapping relationship.

### Composite Partitioning

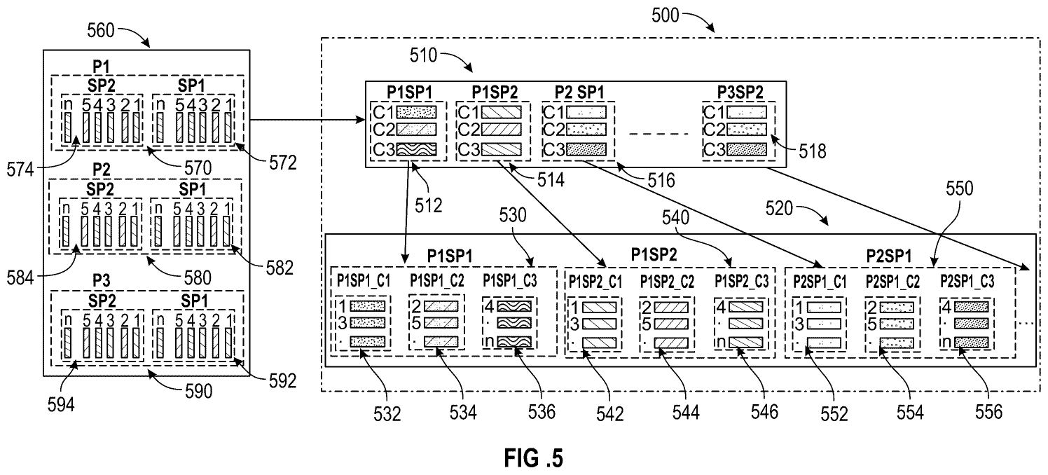

In an embodiment, a base table is partitioned at multiple levels. FIG. 5 is a block diagram that depicts an example partitioned local IVF index 500 that is generated based on a composite partitioned base table, in an embodiment. Partitioned IVF index 500 comprises a centroids table 510 that is partitioned (by partition ID) into partitions 512-518 (there are other partitions in centroids table 510 that are indicated by a dashed line), each of which comprises a different set of centroids and each of which is associated with a subpartition identifier. In this example, base table 560 is also partitioned and is partitioned on the same partitioning key as the partitioning key that IVF index 500 was partitioned.

Each partition of centroids table 510 is associated with a different subpartition of clusters table 520. Clusters table 520 is composite partitioned (first by partition ID and then by centroid ID) to create cluster table partitions 530-550, although more cluster table partitions than these three would exist based on the number of partitions in centroids table 510. Cluster table partitions 530-550 are further subpartitioned based on centroid ID. Thus, clusters table partition 530 comprises cluster subpartitions 532-536 for centroids table partition 512, clusters table partition 540 comprises cluster subpartitions 542-546 for centroids table partition 514, and cluster table partition 550 comprises cluster subpartitions 552-556 for centroids table partition 516. Each subpartition 532-556 corresponds to a different centroid in centroids table 510 and, thus, stores vectors that have been deemed closer (in terms of vector similarity) to that corresponding centroid than to any other centroid in centroids table 510.

Thus, one difference between IVF index 400 and IVF index 500 is that each partition in centroids table 410 corresponds to a different partition in base table 460, whereas each partition in centroids table 510 corresponds to a different subpartition in base table 560. Another difference is that a clustering technique is applied to each partition in base table 460, whereas a clustering technique is applied to each subpartition in base table 560.

In an embodiment, various combinations of partitioning are supported, such as RANGE-LIST, RANGE-HASH, LIST-RANGE, LIST-HASH, INTERVAL-RANGE, and so forth. For example, in FIG. 5, base table 560 is RANGE-RANGE composite partitioned, while centroids table 510 is LIST partitioned by partition ID and clusters table 520 is LIST partitioned by partition ID and LIST subpartitioned by centroid ID.

This embodiment may be extended to scenarios where the base table has more than two levels of a partitioning hierarchy. This extension is possible because the partitioned IVF index only relies on the ability to create a unique object ID per base table “fragment” (or lowest/leaf-level subpartition in the base table) to represent the partition ID column in the centroids table and the partitions of the clusters table.

### Flexible Clustering Model

In an embodiment, for each partition or subpartition in a base table (e.g., base table 460), an independent cluster model (e.g., a K-means model) is automatically generated. The centroids produced from the cluster model are stored in the corresponding partition in the centroids table (e.g., centroids table 410). Even if all partitions in the centroids table use the same cluster model, the clustering is still performed for each base table partition internally based on its data characteristics. This improves model accuracy since the data distribution, feature correlation, or other characteristics in one base table partition could be dramatically different than those in other base table partitions. Additionally, the number of centroids for one partition of the centroids table may be vastly different than the number of centroids for another partition of the centroids table. This difference may be due to the size of the partition itself and the partition's data distribution.

In an embodiment, different partitions or subpartitions of a base table are clustered using different clustering techniques. For example, the vectors in partition 462 of base table 460 are clustered based on K-means clustering (which produces a set of centroids) while the vectors in partition 464 of base table 460 are clustered based on Fuzzy C-Means (FCM) clustering (which produces another set of centroids). As another example, vectors in partition 462 of base table 460 and vectors in partition 464 of base table 460 are clustered using the same clustering technique but different distance metrics are used. Example vector distance metrics include Euclidean distance, Euclidean squared distance, cosine similarity, dot product similarity, Manhattan distance, Hamming distance, and Jaccard similarity.

### Adding New Partitions

In some scenarios, a new set of data is added to a base table (e.g., base table 460) as a new partition. In order to access that data during a vector search involving an IVF index (e.g., partitioned IVF index 400), one of multiple approaches may be implemented. In one example, a vector search involves (1) traversing the IVF index as well as (2) performing a table scan of the new partition, and (3) merging the results.

In another example, if the IVF index is a local partitioned index where a different IVF index is effectively built on each base table partition (e.g., in FIG. 4), then a new IVF index is generated based on the new partition and that new IVF index is added to the local IVF index. Thus, a centroids table of a partitioned IVF index may “naturally” grow (or shrink) by adding/dropping centroids table partitions, including merging or splitting centroids table partitions. In a related embodiment of this example, instead of performing a clustering technique on the vectors in the new partition, existing centroids are used to determine centroids for the new IVF index.

In one technique, the centroids of an existing partition of the centroids table of the local, partitioned IVF index are used as the centroids for the new partition. Selecting the existing partition may be random or may be selected based on a similarity between one or more characteristics of the new base table partition and one or more characteristics of the base table partition corresponding to the existing partition of the centroids table. For example, a relational attribute of the new partition may be the same or similar to (e.g., have a similar data distribution) as the relational attribute of the base table partition corresponding to the existing partition of the centroids table.

In another technique, existing centroids are aggregated (e.g., averaged, identifying the median, etc.) to generate new centroids for the new IVF index partition to be constructed on the new base table partition. Whichever technique is used to determine centroids for the new IVF index partition, each vector in the new partition is compared to each newly-determined centroid to identify the newly-determined centroid that is closed to the vector, and the vector is added to the corresponding new centroid cluster.

### Flexible Partition-Level Reclustering

In an embodiment, a base table partition is reclustered automatically. One or more criteria may be considered in order to trigger an automatic reclustering of a base table partition. Examples of criteria include how long it has been since the base table partition has been re-clustered, how much data in the corresponding base table partition have changed (e.g., updated, deleted, inserted) (if the IVF index is a local IVF index), how much data in the corresponding base table has changed (if the IVF index is a global IVF index), how much the data distribution of a base table partition has changed, how query access patterns have changed. Thus, vectors in each base table partition (or subpartition) may be re-clustered independently depending on DML activity, changes in data distribution, or query access patterns. For example, a base table contains data about houses for sale and the base table is partitioned by zipcode. The VECTOR column embeds the text description of the house listing. It is possible for certain zipcodes where there are rapid changes as listed houses are sold and new houses are added on the market frequently. It may be desirable to re-cluster the partition(s) responsible for such zipcodes more frequently than those in zipcodes that are associated with fewer listing changes.

Another criterion that may trigger an automatic re-clustering is the accuracy of results of vector queries (either on a global IVF index or on a local partitioned IVF index). Vector query accuracy may be computed by performing a base table scan for some vector queries and comparing the results. Such base table scans may be performed regularly, such as a every given time period (e.g., once per day) or every N (e.g., twenty) vector queries that target the IVF index (whether global or a partition thereof, if the IVF index is a local partitioned IVF index).

In an embodiment, the number of times reclustering is performed triggers selection of a different clustering technique than the one that was used to cluster a current set of vectors (whether from a particular partition of the base table or from the entire base table). For example, despite reclustering a set of vectors corresponding to an IVF index, vector query performance may be relatively low. For example, accuracy may be consistently under 80%. Such poor performance may be due to a poor-performing clustering technique. One approach to increase accuracy is to increase the number of clusters to probe. However, this may dramatically increase query processing latency. A goal is to increase accuracy while keeping constant the number of clusters to probe, which maintains a relatively stable query latency. Therefore, the database system determines to select a different clustering technique for the set of vectors. The different clustering technique may be different than the clustering technique that is used to clusters sets of vectors from the same base table (e.g., sets of vectors corresponding other partitions of the base table).

### Adaptive Computation of the Number of Clusters

In some scenarios, the number of vectors in a base table may be relatively significant, such as over a billion vectors or even over a trillion vectors. Performing a clustering technique that takes into account each vector in such a base table may take hours or days to complete. Therefore, it is prudent to only consider a strict subset of the vectors in such a base table.

In an embodiment, a sampling technique is combined with the number of vectors per cluster in order to satisfy a user-specified (or a default) number of clusters in an IVF index. For example, a sampling ratio is computed in two main steps. In the first step, computing a number of clusters by dividing the number of rows (or vectors) in a base table of vectors by 256 or another default number. (Alternatively, a database user may control this number, such as through a data definition language (DDL) statement. Thus, this number may be a default number that a provider of the vector search service establishes or may be a number that a user of the service sets, such as a higher number for the clustering to be more accurate.) In the second step, an initial sampling ratio is computed by dividing the number of clusters (which may be specified by a user or may be a default number) by the number of clusters computed in the first step. If the initial sampling ratio is greater than a relatively high ratio (e.g., 90%), then no sampling is performed. If the initial sampling ratio is less than a minimal sampling ratio (e.g., 1%), then the number of vectors per cluster (e.g., 256) is adjusted to increase the sampling ratio to at least the minimal sampling ratio (e.g., 1%). For example, if the initial sampling ratio is less than the minimal sampling ratio, then the number of data vectors per cluster is increased by a fixed amount (e.g., one) from 256 until the user-specified number of clusters in the index is satisfied. Otherwise (if the initial sampling ratio is between 90% and the minimal sampling ratio (e.g., 1%)), the computed initial sampling ratio becomes the final sampling ratio in order to perform the sampling.

Given a final sampling ratio, a process of database server 130 identifies that percentage of vectors in a base table (or each partition or subpartition of the base table) and performs clustering on the sampled vectors in order to generate a partitioned IVF index or a global IVF index.

### Flexible Index Partitioning

In an embodiment, an AUTO LIST partitioning method and a manual partitioning method are supported for both the centroids table (e.g., centroids table 410) and the clusters table (e.g., clusters table 420). Those partitioning methods may be configured through system or session variables.

For a clusters table (e.g., clusters table 420), the following partitioning methods may be: LIST/LIST, LIST/HASH, LIST/RANGE, RANGE/LIST, RANGE/RANGE. LIST/LIST is an efficient partitioning strategy. However, if the number of base table fragments is large (e.g., a composite HASH/HASH table partitioning scheme with 1000×1000 fragments), then the LIST/LIST scheme may prove to be inefficient. In such scenarios, using a RANGE/LIST partitioning scheme might be more efficient as that reduces the number of partitions in the local IVF index.

### Rewriting Vector Queries Using a Partitioned IVF Index

A significant advantage of a local partitioned IVF index is the ability to prune unnecessary partitions so that those index partitions are not scanned during an index scan. By applying the results of the same partition pruning conditions on the base table to both the centroids table and the clusters table of a partitioned IVF index, vector queries only need to scan corresponding partitions in the centroids table and “join” the results with the corresponding partitions in the clusters table. Such pruning, in many instances, dramatically (1) reduces the number of distance computations between the query vector (of a vector query) and vectors in the clusters table and (2) speeds up the vector query by orders of magnitude.

To illustrate the pruning of partitions from a partitioned IVF index, two rewrite scenarios are described: a query rewrite without a filter to prune IVF index partitions and a query rewrite with a filter to prune IVF index partitions. An example of a vector query where there is no partition filter in the rewrite of the vector query is the following:

```
SELECT *
  FROM (SELECT T2.unique2, T2.ten
    FROM T2
    ORDER BY VECTOR_DISTANCE(T2.vec_col, vector(‘[4.3,2.1]’,
    2, FLOAT32)))
V1
  WHERE rownum <= 100;
```

This vector query may be rewritten using internal tables from an IVF index using the following main steps. First, the M closest centroid vectors from all partitions in the centroids table to the query vector are identified. Second, the centroid ID and the partition ID of these centroid vectors are used to select corresponding partitions and subpartitions in the clusters table, and joined with rows from these matched subpartitions in the clusters table only, the distance of the query vector with all matched vectors is computed, and the closest N vectors are selected. Third, the closest N vector rows from the clusters table are joined with the base table to fetch any non-vector columns.

An example of the rewritten query using the above input vector query is as follows:

```
SELECT V1.unique2, V1.ten
  FROM (SELECT T2.unique2, T2.ten
    FROM (SELECT VW_IVPSJ.base_table_rowid,
    VW_IVPSJ.VEC_DIST
      FROM (SELECT CP.base_table_rowid,
            VECTOR_DISTANCE(CP.data_vector,
            vector(‘[4.3,2.1]’,2, float32)) VEC_DIST
        FROM (SELECT centroid_id, partition_id
          FROM (SELECT centroid_id, partition_id
              FROM VECTOR$T2IX2$IVF_FLAT_CENTROIDS
              ORDER BY VECTOR_DISTANCE(centroid_vector,
                vector(‘[4.3,2.1]’,2,float32))) VW_IVCN
          WHERE rownum <= 5) VW_IVCR,
          VECTOR$T2IX2$IVF_FLAT_CENTROID_PARTITIONS
          CP
        WHERE VW_IVCR_3.centroid_id = CP.centroid_id AND
          VW_IVCR_3.partition_id = CP.partition_id
        ORDER BY VEC_DIST) VW_IVPSJ
      WHERE rownum <= 100) VW_IVPSR, T2
    WHERE T2.rowid = VW_IVPSR.base_table_rowid
    ORDER BY VW_IVPSR.VEC_DIST) V1;
```

For vector queries with partition filters, if any partition pruning conditions exist, then rewriting a vector query may be performed by: (1) identifying base table partitions or subpartitions associated with one or more partition pruning conditions; (2) using an object ID of partitions from (1) to find corresponding partitions in the centroids table (of the partitioned IVF index) and searching only these partitions to identify the M closest centroid vectors to the query vector; (3) using the centroid ID and the partition ID of the M closest centroids vectors from the centroids table to select corresponding partitions and subpartitions in the clusters table and to join with rows from these matched subpartitions only in the clusters table to identify the N closest data vectors in the clusters table; and (4) joining back these rows with the base table to fetch any non-vector columns.

An example of a vector query where there is a partition filter in the rewrite of the vector query is the following:

```
SELECT *
  FROM (SELECT T2.unique2, T2.ten, D2.thousand
    FROM T2, D2
    WHERE T2.unique3 > 20 and T2.unique2 = 2 and D2.pk_col =
    T2.fk_col
    ORDER BY VECTOR_DISTANCE(T2.vec_col,
      vector(‘[4.3,2.1]’, 2, FLOAT32))) V1
  WHERE rownum <= 100;
```

After the rewrite, the query likes this:

```
SELECT V1.unique2, V1.ten, V1.thousand
  FROM (SELECT T2.unique2, T2.ten, D2.thousand
    FROM (SELECT VW_IVCN.centroid_id
        FROM (SELECT /*+ nested_loop*/ centroid_id, partition_id
          FROM CENTROIDS
          WHERE partition_id in ( SELECT
          SYS_OP_ROWIDTOOBJ(rowid)
                FROM T2 WHERE T2.unique2 =2 and rownum = 1 )
          ORDER BY VECTOR_DISTANCE(centroid_vector,
              vector(‘[4.3,2.1]’,2, float32))) VW_IVCN
        WHERE rownum <= 5) VW_IVCR,
      CENTROID_PARTITIONS CP, T2, D2
    WHERE T2.unique3 > 20 and T2.unique2 = 2 and D2.pk_col =
    T2.fk_col AND
        T2.rowid = CP.base table_rowid and
        VW_IVCR.centroid_id = CP.centroid_id AND
        VW_IVCR.partition_id = CP.partition_id
    ORDER BY VECTOR_DISTANCE(T2.vec_col,
            vector(‘[4.3,2.1]’,2,float 32))) V1
WHERE rownum <= 100;
```

### In-Memory Centroids Cache

In an embodiment, centroid vectors in a centroids table (e.g., centroids table 410) are laid out in contiguous in-memory chunks for faster access. This helps in reducing the time taken to identify the best centroid assignment for a given vector during index creation, DMLs, and query execution. Benefits of such an in-memory arrangement include (1) replacing (a) random I/Os while accessing the centroids table in the buffer cache with (b) sequential in-memory access and (2) the ability to use a more efficient batched SIMD distance computation logic to compute distances between a query vector and the centroid vectors.

In a related embodiment, an in-memory centroids cache is maintained only once after the centroids are created or reclustered. The cache may be duplicated across multiple database nodes for uniform performance in a multi-node deployment. Background population logic may be implemented in case the in-memory centroids cache cannot be loaded due to a node restart or lack of availability of in-memory space during index creation time.

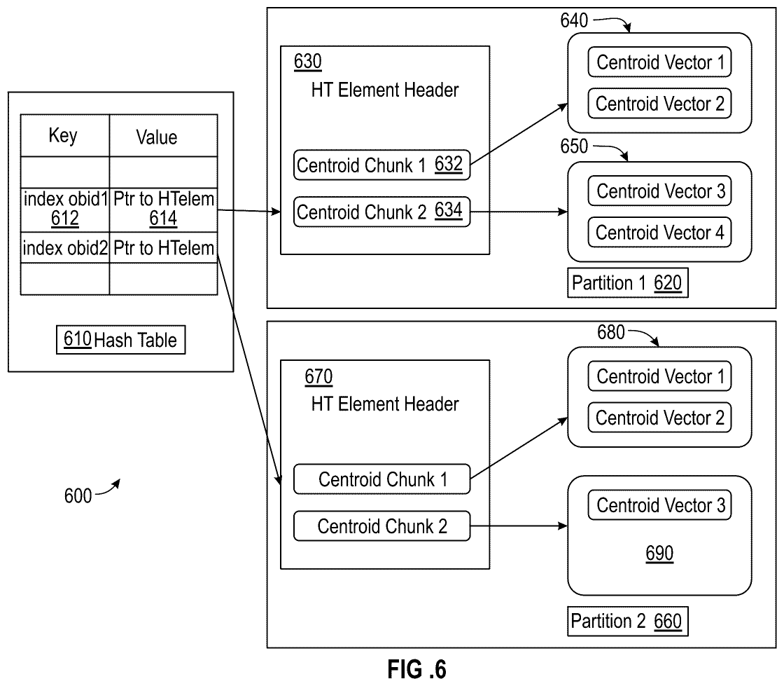

FIG. 6 is a block diagram that depicts an example in-memory centroids cache 600 for a partitioned IVF index, in an embodiment. In-memory centroids cache 600 includes a top-level hash mapping 610 that associates an index partition object identifier with a reference to an element header comprising one or more chunk references. Each index partition object identifier uniquely identifies an index partition in a partitioned IVF index. The value of an index partition object identifier may be hashed to identify an entry or row in hash mapping 610.

The centroid vectors 1-4 in cache partition 620 may correspond to centroid table partition 432 while the centroid vectors 1-3 in cache partition 660 may correspond to centroids table partition 434. Each cache partition stores an element header that includes one or more chunk references, where each chunk reference references or points to a set of contiguous centroid vectors pertaining to the corresponding index partition. The centroid vectors that are pointed to by an element header correspond to the index partition that is identified by the index partition object identifier with which the element header corresponds. For example, hash mapping 610 comprises an entry (associating index object ID 612 with HT element reference 614) that references an HT element header 630 (which is part of partition 620). HT element header 630 includes two centroid chunk references 632 and 634. Centroid chunk reference 632 references chunk 640 (which comprises two centroid vectors) while centroid chunk reference 634 references chunk 650 (which comprises two different centroid vectors).

Similarly, hash table 610 comprises another mapping that references an HT element header 670 (which is part of partition 660). HT element header 670 includes two centroid chunk references: one that references chunk 680 (which comprises two centroid vectors) while the other chunk reference references chunk 690 (which comprises a single centroid vectors).

If the partitioned IVF index is rebuilt, i.e., the data of any partition is reclustered (which reclustering may be automatically triggered as a result of detecting a change in data distribution), then the corresponding centroids cache is recreated as well.

### Reclustering for a Partitioned IVF Index

In some instances, there may be significant skew in the number of vectors in base table partitions. Thus, it is highly likely that there are some small partitions that have no meaningful centroids. Such partitions will not have an effective IVF index to start with given the lack of meaningful centroids.

In an embodiment, a background IVF re-clustering technique creates meaningful centroids for such partitions. One re-clustering technique is as follows.

First, identify candidate index partitions that need a re-clustering. Candidate index partitions for re-clustering include (a) index partitions that have a low centroid-to-number of base table rows ratio and (b) index partitions that have relatively low query accuracy scores. A query accuracy score of an index partition may be considered “low” if the score is below a particular score threshold, which may be a default threshold or a user-specified threshold. A query accuracy score for an index partition may be generated by aggregating multiple accuracy scores for queries on that index partition. Examples of aggregation include mean, median, or other percentile.

Second, generate a new centroids table that inherits the centroids from the index partitions that are not determined to be re-clustered.

Third, compute clustering (e.g., K-means) parameters for a new cluster model that is to be created. Example clustering parameters include sampling percentage, number of centroids for the partitions undergoing a re-clustering, etc. Some parameters may be associated with default values, which may or may not be overridden by user input.

Fourth, generate a new cluster model to obtain a new set of centroids for an index partition. The cluster model can use the old centroids as a warm start for the cluster model. This means that the old centroids are used as a start point (or a base) to gradually adjust the centroids to minimize the total distance from the vectors in the base table partition to their closest centroids. If the old centroids do not represent the current data distribution, then a cold start with a random centroid initialization is preferred. A cold start means that random vectors will be used as initial centroids and then those initial centroids are adjusted to minimize the respective vector distances. Thus, a warm start can speed up the re-clustering process.

Fifth, the vectors belonging to an index partition that is the subject of a re-clustering are re-assigned based on the new set of centroids. Such re-assignment may be performed in one of multiple ways. One option is to have dummy partitions in the clusters table (e.g., clusters table 420) containing the new centroid assignment. Once the centroid-vectors assignment is complete, the old partitions are dropped, and the dummy partitions are switched to have the centroid-vectors assignment for the partition vectors. Another option is to have a new clusters table that inherits the old centroid-vectors assignment for the index partitions that did not need a re-clustering and has the new centroid-vectors assignment for the index partitions that went through an IVF re-clustering.

Sixth, populate an in-memory centroids cache with the new centroids for the index partitions that went through a re-clustering.

Seventh, update a vector index catalog table to indicate the new centroids and the new clusters table.

Eighth, invalidate base table cursors so that future plans are generated that refer to the new centroids.

Ninth, the old in-memory centroids cache and the old centroids and the old clusters table are dropped after quiescing existing readers. In other words, if vector query processor 132 is still processing a vector query and the vector query (or execution plan thereof) involves the old in-memory centroids cache, then the old in-memory centroids cache is not dropped. Database server 130 will wait until the processing of the vector query is complete before dropping the old in-memory centroids cache.

### Partition Maintenance Operations

In an embodiment, database server 130 supports one or more partition maintenance operations (PMOPs) on a base table, which affects the partitions in the corresponding partitioned IVF index. Examples of PMOPs include split partition, merge partition, drop partition, add partition, exchange partition, and truncate partition.

In an embodiment, an index partition is the subject of a split partition operation, resulting in two index partitions that are considered “children” of the “parent” index partition. A split partition operation may be performed in response to a split base table partition operation. Such an operation may automatically trigger the split of the corresponding index partition, in the scenario where the IVF index is a partition local IVF index.

There are at least two ways to perform a split index partition operation. One way is performing a clustering technique on each set of vectors, each set of vectors corresponding to a different one of the two children index partitions. The clustering technique results in two new sets of centroids, one new set for each of the two children index partitions. Another way to perform a split index partition operation is to copy of the centroids of the parent index partition and use the copy as the centroids of both children index partitions. No changes are needed in the clusters table because the same model as before is used except that the old partition ID is updated to a new partition ID for the rows moved into the new partition in the clusters table.

In an embodiment, adding a new range or list partition or subpartition to a partitioned IVF index does not introduce any row movements in the corresponding base table. The newly added partitions or subpartitions are empty partitions. When DML statements insert vectors to corresponding [sub]partitions in the base table, those vectors are automatically assigned to the corresponding centroids. In order to facilitate DML operations on the base table, a cluster (e.g., K-means) model from a previous or subsequent partition/subpartition is “inherited.” The vectors assigned to the newly added partition/subpartition may be re-clustered eventually.

In an embodiment, two or more base table partitions are merged into a single partition in the base table. In response to this merging, a corresponding local partitioned IVF index obtains a cluster model for the new partition using one of the following options.

In a first option, the model from the partition that has the most rows among all partitions to be merged is selected to be used for the new partition. In this case, only the rows from the other partitions that are being merged need to be re-assigned. The merge operation should be relatively fast because there is no need to build a new model and the fewest number of rows are being reassigned.

In a second option, the centroids from all partitions that are being merged into one model are combined (or unioned) and each centroid is relabeled with a new centroid ID. No reassignment is needed, but rows from partitions to be merged will need to be updated with their new centroid ID and partition ID.

In a third option, the newly formed partition is re-clustered with a new cluster model. Each row in the clusters table from the merged partitions is reassigned to its closest centroid/cluster in the new cluster model.

### Process Overview

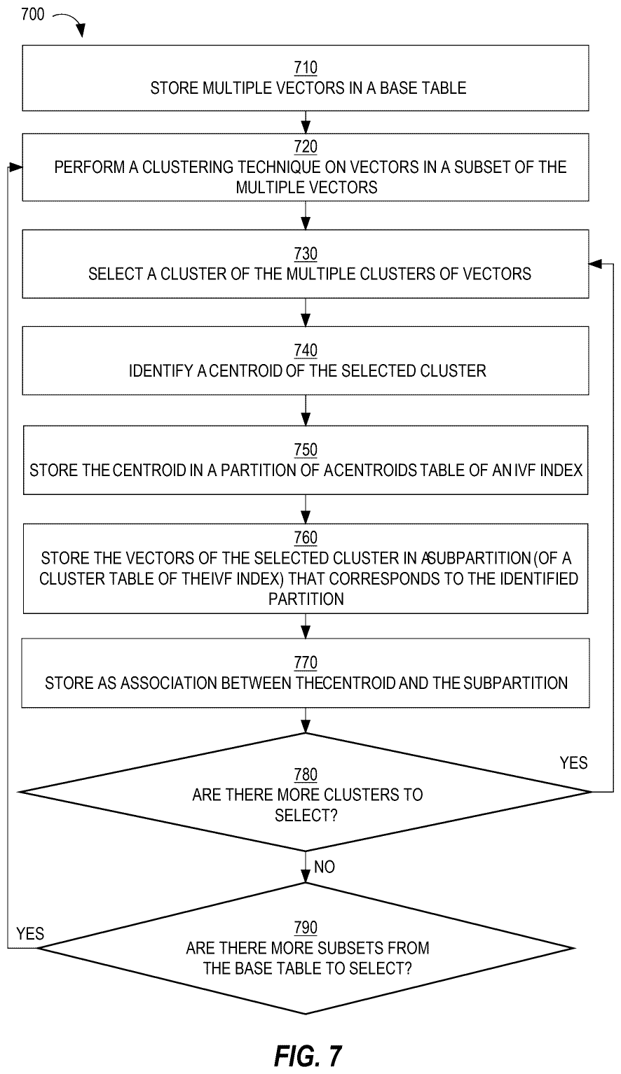

FIG. 7 is a flow diagram that depicts an example process 700 for generating a partitioned IVF index based on vectors in a base table, in an embodiment.

At block 710, multiple vectors are stored in the base table. The base table may be stored in database 140.

At block 720, a clustering technique is performed on vectors in a subset of the multiple vectors. The subset may be a partition of the base table. Alternatively, the subset may be identified based on a certain predicate or condition that is applied to the base table to identify a certain set of rows that satisfy the predicate/condition. Performing the clustering technique results in multiple clusters of vectors.

At block 730, a cluster of the multiple clusters of vectors is selected. This selection may be random.

At block 740, a centroid of the selected cluster is identified. The identity of the centroid may be a result of the clustering technique.

At block 750, the centroid is stored in a partition of a centroids table of the IVF index. Block 750 may involve identifying the partition to which the centroid belongs. Each centroid that is identified from the multiple clusters of vectors resulting from the most recent iteration of block 720 is stored in the same partition of the centroids table. The creation of a centroids table and of a clusters table of the IVF index may have been performed previous to block 750.

At block 760, the vectors in the selected cluster are stored in a subpartition of a clusters table (of the IVF index) that corresponds to the identified partition in block 750.

At block 770, an association between the centroid (identified in block 740) and the subpartition (identified in block 760) is stored (in the partitioned IVF index) so that processing of subsequent vector queries on the partitioned IVF index can identify and scan the appropriate subpartitions, avoiding the scanning irrelevant subpartitions of the clusters table.

At block 780, it is determined whether there are more clusters to select. If so, then process 700 returns to block 730. Otherwise, process 700 proceeds to block 790.

At block 790, it is determined whether there are more subsets, of the base table, that have not yet had a clustering technique applied to them. If so, then process 700 returns to block 720. Otherwise, process 700 ends.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

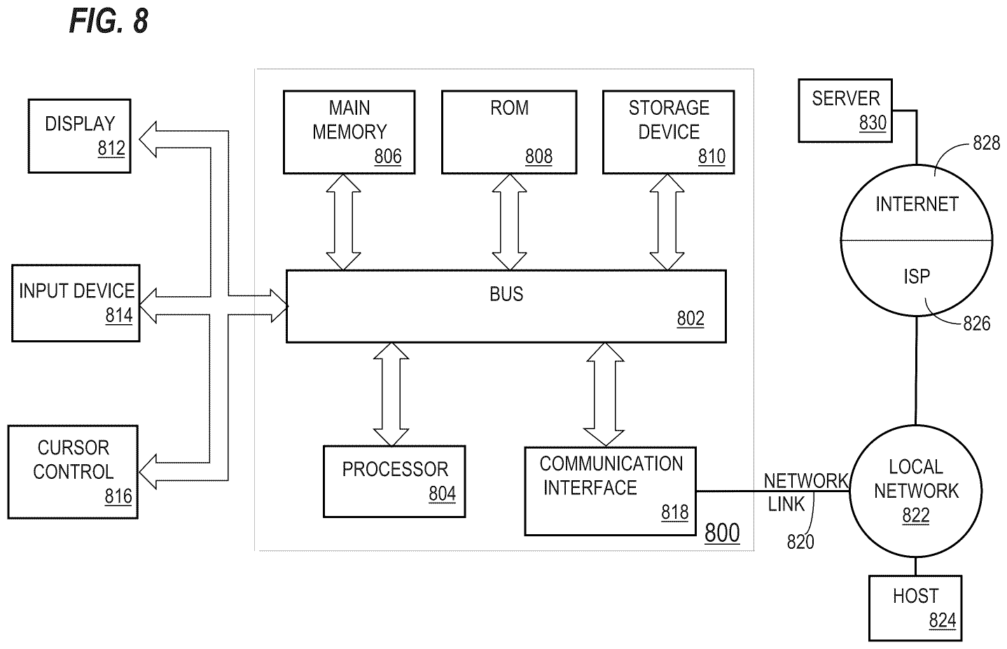

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

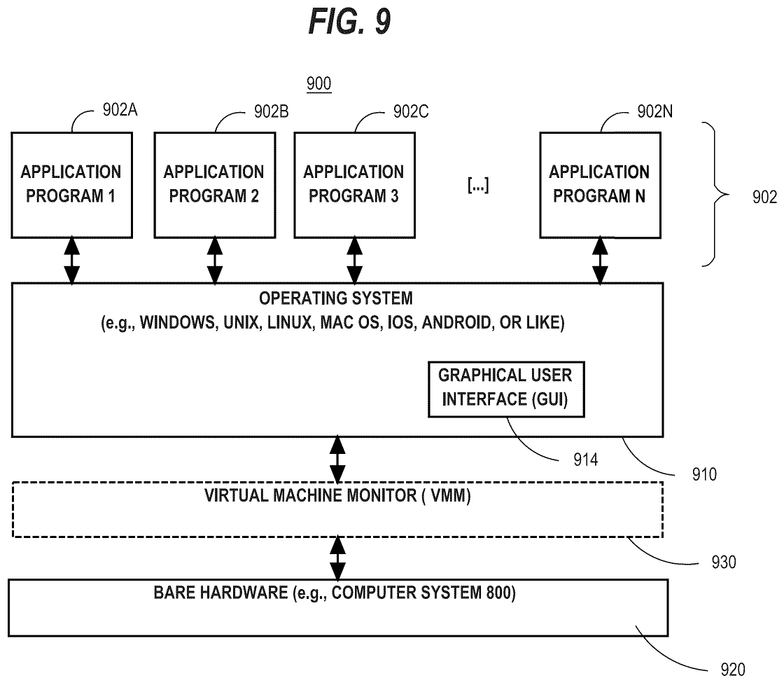

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a plurality of vectors in a base table;
generating a partitioned inverted file (IVF) index based on the plurality of vectors that is stored in the base table, wherein generating the partitioned IVF index comprises:
performing a first clustering technique on vectors in a first subset of the plurality of vectors, wherein performing the first clustering technique results in a first plurality of clusters of vectors;
for each cluster of the first plurality of clusters of vectors:
identifying a centroid of said each cluster;
storing the centroid in a first partition of a centroids table of the partitioned IVF index;
storing the vectors in said each cluster in a first subpartition, of a clusters table of the partitioned IVF index, that correspond to the first partition of the centroids table;
storing, in the partitioned IVF index, a first association between the centroid and the first subpartition;
performing a second clustering technique on vectors in a second subset, of the plurality of vectors, that is different than the first subset, wherein performing the second clustering technique results in a second plurality of clusters of vectors;
for each cluster of the second plurality of clusters of vectors:
identifying a particular centroid of said each cluster;
storing the particular centroid in a second partition of the centroids table of the partitioned IVF index;
storing the vectors in said each cluster in a second subpartition, of the clusters table of the partitioned IVF index, that corresponds to the second partition of the centroids table;
storing, in the partitioned IVF index a second association between the particular centroid and the second subpartition;
wherein the method is performed by one or more computing devices.

2. The method of claim 1, wherein the first clustering technique is different than the second clustering technique.

3. The method of claim 1, wherein:
the first partition of the centroids table corresponds to a first partition or subpartition of the base table;
the second partition of the centroids table corresponds to a second partition or subpartition, of the base table, that is different than the first partition or subpartition of the base table.

4. The method of claim 1, wherein:
the plurality of vectors are partitioned, in the base table, based on a first partitioning key;
the plurality of vectors are partitioned, in the centroids table, based on a second partitioning key that is different than the first partitioning key.

5. The method of claim 1, further comprising:
computing a particular number of clusters based on dividing the number of vectors in the base table by a certain number;
computing a sampling ratio based by dividing a specified number of clusters by the particular number of clusters;
if the sampling ratio is greater than a threshold, then the plurality of subsets comprises all the plurality of vectors;
if the sampling ratio is less than the threshold, then the plurality of subsets comprises less than all the plurality of vectors.

6. The method of claim 1, further comprising:
in response to receiving a vector query that targets the base table, rewriting the vector query to target the partitioned IVF index, wherein rewriting comprises:
identifying one or more partitions of the base table,
based on the one or more partitions of the base table, identifying one or more partitions of the centroids table to exclude from an execution plan of the vector query.

7. The method of claim 1, further comprising:
generating, in memory, a hash table that comprises (1) a key column for storing a plurality of identifiers of partitions of the centroids table and (2) a value column for storing references to a plurality of headers;
for each header of the plurality of headers, storing, in the memory, one or more centroid chunk references;
wherein each centroid chunk reference, of the one or more centroid chunk references, references a contiguous set of centroids that belong to a partition of the centroids table.

8. The method of claim 1, further comprising:
determining an accuracy score for one or more vector queries that involved accessing a particular partition of the centroids table;
based on the accuracy score, performing a third clustering technique on a set of vectors that is associated with the particular partition, wherein performing the third clustering technique results in a third plurality of clusters of vectors;
for each cluster of the third plurality of clusters of vectors:
identifying a certain centroid of said each cluster;
storing the certain centroid in the particular partition of the centroids table of the partitioned IVF index;
storing the vectors in said each cluster in a particular subpartition, of the clusters table, that corresponds to the particular partition of the centroids table;
storing, in the partitioned IVF index, a third association between the certain centroid and the particular subpartition.

9. The method of claim 1, further comprising:
determining, for a particular partition of the centroids table, a ratio of the number of centroids in the particular partition to the number of vectors in a plurality of subpartitions, in the clusters table, that corresponds to the particular partition;
based on the ratio, performing a third clustering technique on a set of vectors that is associated with the particular partition.

10. The method of claim 1, further comprising:
determining to perform a partition operation with respect to a particular partition of the centroids table of the partitioned IVF index;
determining to copy a cluster model, from an existing partition of the centroids table, to the particular partition.

11. One or more non-transitory storage media storing instructions which, when executed by one or more computing devices, cause:
storing a plurality of vectors in a base table;
generating a partitioned inverted file (IVF) index based on the plurality of vectors that is stored in the base table, wherein generating the partitioned IVF index comprises:
performing a first clustering technique on vectors in a first subset of the plurality of vectors, wherein performing the first clustering technique results in a first plurality of clusters of vectors;
for each cluster of the first plurality of clusters of vectors:
identifying a centroid of said each cluster;
storing the centroid in a first partition of a centroids table of the partitioned IVF index;
storing the vectors in said each cluster in a first subpartition, of a clusters table of the partitioned IVF index, that correspond to the first partition of the centroids table;
storing, in the partitioned IVF index, a first association between the centroid and the first subpartition;
performing a second clustering technique on vectors in a second subset, of the plurality of vectors, that is different than the first subset, wherein performing the second clustering technique results in a second plurality of clusters of vectors;
for each cluster of the second plurality of clusters of vectors:
identifying a particular centroid of said each cluster;
storing the particular centroid in a second partition of the centroids table of the partitioned IVF index;
storing the vectors in said each cluster in a second subpartition, of the clusters table of the partitioned IVF index, that corresponds to the second partition of the centroids table;
storing, in the partitioned IVF index a second association between the particular centroid and the second subpartition.

12. The one or more storage media of claim 11, wherein the first clustering technique is different than the second clustering technique.

13. The one or more storage media of claim 11, wherein:
the first partition of the centroids table corresponds to a first partition or subpartition of the base table;
the second partition of the centroids table corresponds to a second partition or subpartition, of the base table, that is different than the first partition or subpartition of the base table.

14. The one or more storage media of claim 11, wherein:
the plurality of vectors are partitioned, in the base table, based on a first partitioning key;
the plurality of vectors are partitioned, in the centroids table, based on a second partitioning key that is different than the first partitioning key.

15. The one or more storage media of claim 11, wherein the instructions, when executed by the one or more computing devices, further cause:
computing a particular number of clusters based on dividing the number of vectors in the base table by a certain number;
computing a sampling ratio based by dividing a specified number of clusters by the particular number of clusters;
if the sampling ratio is greater than a threshold, then the plurality of subsets comprises all the plurality of vectors;
if the sampling ratio is less than the threshold, then the plurality of subsets comprises less than all the plurality of vectors.

16. The one or more storage media of claim 11, wherein the instructions, when executed by the one or more computing devices, further cause:
in response to receiving a vector query that targets the base table, rewriting the vector query to target the partitioned IVF index, wherein rewriting comprises:
identifying one or more partitions of the base table,
based on the one or more partitions of the base table, identifying one or more partitions of the centroids table to exclude from an execution plan of the vector query.

17. The one or more storage media of claim 11, wherein the instructions, when executed by the one or more computing devices, further cause:
generating, in memory, a hash table that comprises (1) a key column for storing a plurality of identifiers of partitions of the centroids table and (2) a value column for storing references to a plurality of headers;
for each header of the plurality of headers, storing, in the memory, one or more centroid chunk references;
wherein each centroid chunk reference, of the one or more centroid chunk references, references a contiguous set of centroids that belong to a partition of the centroids table.

18. The one or more storage media of claim 11, wherein the instructions, when executed by the one or more computing devices, further cause:
determining an accuracy score for one or more vector queries that involved accessing a particular partition of the centroids table;
based on the accuracy score, performing a third clustering technique on a set of vectors that is associated with the particular partition, wherein performing the third clustering technique results in a third plurality of clusters of vectors;
for each cluster of the third plurality of clusters of vectors:
identifying a certain centroid of said each cluster;
storing the certain centroid in the particular partition of the centroids table of the partitioned IVF index;
storing the vectors in said each cluster in a particular subpartition, of the clusters table, that corresponds to the particular partition of the centroids table;
storing, in the partitioned IVF index, a third association between the certain centroid and the particular subpartition.

19. The one or more storage media of claim 11, wherein the instructions, when executed by the one or more computing devices, further cause:
determining, for a particular partition of the centroids table, a ratio of the number of centroids in the particular partition to the number of vectors in a plurality of subpartitions, in the clusters table, that corresponds to the particular partition;
based on the ratio, performing a third clustering technique on a set of vectors that is associated with the particular partition.

20. The one or more storage media of claim 11, wherein the instructions, when executed by the one or more computing devices, further cause:
determining to perform a partition operation with respect to a particular partition of the centroids table of the partitioned IVF index;
determining to copy a cluster model, from an existing partition of the centroids table, to the particular partition.
